(19) United States
(12) Patent Application Publication
(10) Pub. No.: US 2010/0153446 A1
(43) Pub. Date: Jun. 17, 2010

(54) CUSTOMER GOALS USER INTERFACE

(75) Inventor: James Mark Kondziela, Stamford, CT (US)

Correspondence Address: VERIZON;PATENT MANAGEMENT GROUP, 1320 North Court House Road, 9th Floor, ARLINGTON, VA, 22201-2909, US

(73) Assignee: Verizon Data Services, LLC, Temple Terrace, FL (US)

(21) Appl. No.: 12/333,608

(22) Filed: Dec. 12, 2008

(51) Int. Cl. G06F 17/30

(52) U.S. Cl. 707/770; 707/E17.127

(57) ABSTRACT

Exemplary embodiments may provide a computer implemented system and method that may integrate both sales and service functions of a customer service representative on a desktop user interface. A comprehensive set of customer service goals derived from a large sample of actual customer calls may be empirically identified. Desired customer sales goals may be integrated into the comprehensive list of service goals. The integrated set of service and sales goals may be presented in a user interface. A recommendation engine, to present in highlighted form, which subset of goals a customer service representative should pursue with a given customer, when to pursue them, and for how long, may be incorporated. A delineation of a step-by-step process (using “wizards” or “assistants”) may be provided for each goal.

### BACKGROUND INFORMATION

Customer service representative user interfaces (CSR UIs) may be used by customer server representatives (CSRs) to address questions from customers. CSR functions may include both service and sales functions. Service functions (e.g., answering questions about a bill or, asking for a refund due to a mistake) may be both costly and non-revenue generating for a company. However, in contrast to service functions, sales functions may be highly desirable, because sales functions may result in new revenue for the company. Typically, conventional CSR UIs may fail to integrate sales and service functions because they may display to the customer service representative (CSR) as unguided “forms” or “database forms,” wherein a CSR may have to locate, view, and edit numerous database forms to perform both sales and service functions. The service and sales functions may be split into different UIs accessible to certain CSRs.

### BRIEF DESCRIPTION OF THE DRAWINGS

Purposes and advantages of the exemplary embodiments will be apparent to those of ordinary skill in the art from the following detailed description in conjunction with the appended drawings in which like reference characters are used to indicate like elements, and in which:

FIG. 1 depicts a block diagram of a system architecture for a customer service representative system according to an exemplary embodiment;

FIG. 2 depicts a flow chart of a method of integrating customer stated and unstated goals according to an exemplary embodiment;

FIG. 3 depicts a menu architecture for a customer goals user interface according to an exemplary embodiment;

FIG. 4 depicts a menu architecture of a information user interface according to an exemplary embodiment;

FIG. 5 depicts a menu architecture of a customer goals main menu in accordance with an exemplary embodiment;

FIG. 6 depicts a menu architecture of a customer goals sub-menu in accordance with an exemplary embodiment;

FIG. 7 depicts a menu architecture of a notes and profile user interface in accordance with an exemplary embodiment;

FIG. 8 depicts a menu architecture of a user interface according to an exemplary embodiment;

FIG. 9 depicts a menu architecture of a user interface according to an exemplary embodiment;

FIG. 10 depicts a menu architecture of a user interface according to an exemplary embodiment;

FIG. 11 depicts a menu architecture of an alternative user interface according to an exemplary embodiment;

FIG. 12 depicts a menu architecture of a resized user interface according to an exemplary embodiment;

FIG. 13 depicts a menu architecture of an alternative user interface according to an exemplary embodiment;

FIG. 14 depicts a menu architecture of an alternative customer goals main menu in accordance with an exemplary embodiment.

These and other embodiments and advantages will become apparent from the following detailed description, taken in conjunction with the accompanying drawings, illustrating by way of example the principles of the various exemplary embodiments.

### DETAILED DESCRIPTION OF PREFERRED EMBODIMENTS

Exemplary embodiments may provide a computer implemented system and method that may integrate both sales and service functions for a customer service representative (CSR) using a user interface (UI). The UI may be customer goals driven. The system may be a computer based network that has a client side which may reside on a general purpose computer, and be accessed through a UI, such as a Graphical User Interface (GUI). The computer based network may have one or more computer servers where the software for the GUI resides. The servers may provide access to one or more computer databases which may contain customer and product information. The system may be implemented on a portable electronic device, such as a cellular phone or a personal digital assistant (PDA). A recommendation engine may be incorporated into the servers. The recommendation engine may provide recommendations to the CSR concerning goals to address with the customer, beyond the customer's stated goals.

The method may provide a step by step procedure for the CSR to follow when handling a customer call. The method may initially focus on responding to a customer's queries. The customer's queries may be the stated goals of the customer. Following handling of the customer's queries, the method may provide goals, such as unstated goals, for the CSR to present to the customer. The goals to pursue with the customer may be presented as recommendations and the CSR may be provided with goals to pursue with a given customer, when to pursue them, and for how long to pursue them. For both the stated and unstated goals, step by step processes, in the form of menus and UIs, such as wizard, may be provided for the CSR. The step by step process may provide the CSR with guidance on how to proceed with each goal.

The description below describes servers, portable electronic devices, and other computing devices that may include one or more modules, some of which are explicitly depicted in the figures, others are not. As used herein, the term “module” may be understood to refer to executable software, firmware, hardware, and/or various combinations thereof. It is noted that the modules are exemplary. The modules may be combined, integrated, separated, and/or duplicated to support various applications. Also, a function described herein as being performed at a particular module may be performed at one or more other modules and/or by one or more other devices (e.g., servers) instead of or in addition to the function performed at the particular module. Further, the modules may be implemented across multiple devices and/or other components local or remote to one another. Additionally, the modules may be moved from one device and added to another device, and/or may be included in both devices. It is further noted that the software described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of storing software, and/or combinations thereof. Moreover, the figures illustrate various components (e.g., servers, portable electronic devices, client devices, computers, etc.) separately. The functions described as being performed at various components may be performed at other components, and the various components may be combined and/or separated. Other modifications also may be made.

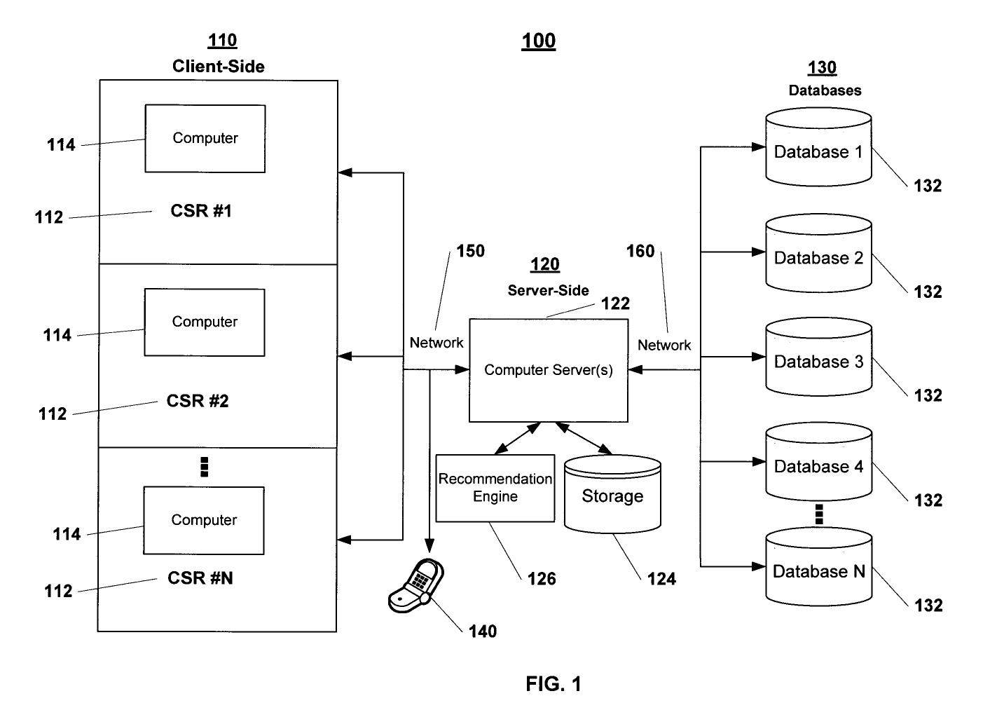

FIG. 1 depicts a block diagram of a system architecture for a CSR system according to an exemplary embodiment. The CSR system 100 may include, among other things, a client side 110, a server side 120, one or more databases 130, and one or more mobile devices 140. Computer network 150 may provide communications paths between the client side 110 and/or the mobile devices 140, and the server side 120. Computer network 160 may provide communication between the server side 120 and the one or more databases 130. Other various network components and embodiments may be provided.

The client side 110 may consist of one or more CSRs 112. Each CSR may have a processing machine 114, such as a general purpose computer. Each processing machine 114 may include client software, such as software in accordance with an exemplary embodiment. Each processing machine 114 may provide processing, display, storage, communications, and execution of commands in response to inputs from the CSR and the requests from the software. The client side 110 may be a fat client, such that the majority of the processing may be performed on the client side 110. Alternatively, the client side 110 may be a thin client, such that the majority of the processing may be performed on the server side 120. At a minimum, the client side 114 may provide the CSR with a display and at least one entry device to facilitate entry of information into the UIs in accordance with an exemplary embodiment. For example, a monitor, a keyboard and a mouse may be provided. The client side 110 may have a phone system (not shown). The phone system may answer incoming customer calls. The phone system may be integrated into and/or associated with the processing machine 114. The integration of the phone system with the processing machine 114 may provide information from the phone call into the processing machine 114, such as the caller ID information for the phone call. Audio devices (not shown), such as a speaker and microphone, may be provided to allow the CSR to hear the customer and speak with the customer.

The server side 120 may consist of one or more servers 122. The servers 122 may contain storage capability for the software and other data, such as the storage 124. In an exemplary embodiment, the server side 120 may provide storage of the majority of the data for an exemplary embodiment. The servers 122 may provide processing capability in accordance with an exemplary embodiment. The servers 122 may consist of one or more computer processors. The computer processors may provide for the processing of the software commands and data. The server side 120 may be structured accordingly to the type of client used in the client side 110. For example, if the client side 110 is a thin client, the server side 120 may be structured with processing capability to perform the majority of the processing required by an exemplary embodiment. Conversely, if the client side 110 is a fat client, the server side 120 may structured with processing capability to perform less processing than for aforementioned thin client example.

The storage 124 may consist of one of more data storage devices. The storage 124 may be local, remote, or a combination thereof with respect to the server 120. The storage 124 may utilize a redundant array of disks (RAID), striped disks, hot spare disks, tape, disk, or other computer accessible storage. In one or more embodiments, the storage 124 may be a storage area network (SAN), an Internet small computer systems interface (iSCSI) SAN, a Fibre Channel SAN, a common Internet File System (CIFS), network attached storage (NAS), or a network file system (NFS). The storage 124 may have back-up capability built-in or communicatively coupled. The back-up capability of the storage may be used to archive image data for later use. The back-up capability may be used for recovery of data in the event of a failure of the storage.

The server side 120 may contain a recommendation engine 126. The recommendation engine 126 may be integrated with the servers 122. In some embodiments, the recommendation engine 126 may stand-alone and may be communicatively coupled to the servers 122. The recommendation engine 126 may provide recommended goals for a CSR to pursue with a given customer, when to pursue them, and for how long to pursue them. The recommendation engine 126 may be programmed to process data relating to a given customer and provide recommendations of goals for the CSR. The recommendation engine 126 may provide the recommendation in the form of designated entries in the list of customer goals. The recommended goals may be displayed in a manner for the CSR to notice them. For example, the recommended goals may be highlighted, such as highlighting in yellow. The recommendation engine 126 may be programmed to present a default list of goals to pursue with each customer. Specific details for each recommendation may be provided.

One or more portable electronic devices 140 may be provided. The portable electronic devices 140 may consist of a cell phone or another mobile communication device, such as a personal digital assistant (PDA), e.g., a smart phone, or a Blackberry. The portable electronic device 140 may have a software module containing the software to execute an exemplary embodiment. Embodiments of the present invention may be accessed and used on the portable electronic devices 140.

The databases 130 may consist of one or more databases 132. The databases 132 may be co-located and/or remotely located in relation to the server side 120. The databases 132 may contain customer and product information. The customer and product information may be stored together or separately across multiple databases. Other information may be resident on the databases 132, separate from the customer and product information. In one or more exemplary embodiments, the databases 132 may reside on a storage medium, such as storage 124.

The databases 132 may serve to store data and information. Such data and information may be searched for and retrieved from the databases 132. The databases 132 may include any suitable data structure to maintain the information and allow access and retrieval of the information. For example, the databases 132 may keep the data in an organized fashion. Types of databases include an Oracle database, a Microsoft SQL Server database, a DB2 database, a MySQL database, a Sybase database, an object oriented database, a hierarchical database, a flat database, and/or another type of database capable of serving and storing data as may be known in the art.

A computer based network 150 may be provided. The computer based network 150 may provide a communications path between the client side 110 and the server side 120. The computer based network 150 may comprise one or more computer networks. A combination of different types of computer networks may be used. The computer based network 150 may provide a communications path for the portable electronic devices 140 to communicatively couple with the server side 120. Preferably, a wireless communications path may be used for the portable electronic device 140 to communicatively couple with the server side 120. For example, a wireless signal may be used.

A computer based network 160 may be provided. The computer based network 160 may provide a communications path between the server side 120 and the database side 130. The computer based network 160 may consist of more than one computer network. A combination of different types of computer networks may be used. In some embodiments, the computer based network 160 may be a similar network to the computer network 150.

The communications path, such as the computer based network 150, may be any suitable communications path. A wireless signal may be used. The wireless signal may consist of Bluetooth, Wireless Application Protocol (WAP), Multimedia Messaging Service (MMS), Enhanced Messaging Service (EMS), Short Message Service (SMS), Global System for Mobile Communications (GSM) based systems, Code Division Multiple Access (CDMA) based systems, Transmission Control Protocol/Internet (TCP/IP) Protocols, or other protocols and/or systems suitable for transmitting and receiving data. The portable electronic device and the server may use standard wireless protocols including IEEE 802.11a, 802.11b, 802.11g, and 802.11n.

The communications path may be a network, such as a local area network or communications may be over a direct connection. Data may be transmitted and/or received from over the communications path. Data transmission and receipt may utilize cabled network or telecom connections such as an Ethernet RJ45/Category 5 Ethernet connection, a fiber connection, a traditional phone wireline connection, a cable connection or other wired network connection. It is understood that a combination of networks may used, such as a combination of wired and wireless networks.

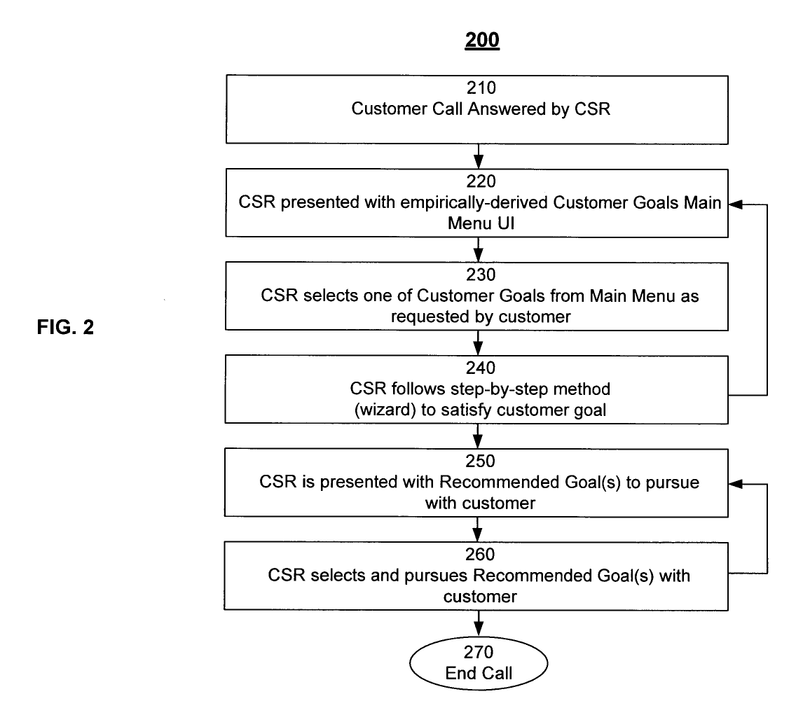

FIG. 2 depicts a flow chart of a method of integrating customer stated and unstated goals according to an exemplary embodiment. Exemplary method 200 is provided by way of example, as there are a variety of ways to carry out the methods disclosed herein. The method 200 as shown in FIG. 2 may be executed or otherwise performed by one or a combination of various systems, such as a computer implemented system. Each block shown in FIG. 2 represents one or more processes, methods, and/or subroutines carried out in the exemplary method 200. Each block may have an associated processing machine or the blocks depicted may be carried out through one processor machine. Input may be desired from a user during various parts of the below described method, the input may be accomplished through a user interface. The exemplary method 200 may be carried out on a computer based system such as the system 100 depicted in FIG. 1. In the description of the exemplary method 200, elements of FIG. 1 may be referred to.

While the method of FIG. 2 illustrates certain steps performed in a particular order, it should be understood that the embodiments of the present invention may be practiced by adding one or more steps to the processes, omitting steps within the processes and/or altering the order in which one or more steps are performed.

At block 210, a customer call may be answered by a CSR. The call may typically originate from a customer to a CSR, such as CSR 112. The CSR may receive the call based on a queuing assignment from a phone system associated with the CSR's company. For example, the company may have a finite number of CSRs. The incoming volume of phone calls may exceed the finite number of CSRs. The company may use a queuing system such that customers awaiting assistance may be placed into a holding queue to await the next available CSR. Customers may therefore be randomly assigned to CSRs. In some embodiments, customers may be assigned to CSRs based upon their needs. For example, the customer may require an adjustment to a bill. The customer may select an option from a phone tree menu. The customer may then be assigned to an appropriate CSR who may handle such matters. It should be appreciated that a combination of random and specific assignments may be used. For example, there may be a number of CSRs who handle billing adjustments and a queue of customers awaiting assistance. The customers may be then assigned to the next available CSR based on position in the queue and CSR availability.

Alternatively, the CSR 112 may have a portable electronic device 140. The CSR 112 may be a salesman at a customer's location. The CSR 112 may use the portable electronic device 140 to perform the method described herein. The UI may be presented on the screen of the portable electronic device 140.

Continuing at block 220, the CSR 112 may be presented with a customer goals main menu UI. The UI may be presented on a computer associated with the CSR 112, such as processing machine 114. The UI may be a Graphical User Interface (GUI). The computer display may have the UI present thereupon. The UI may have a number of choices based on common (and uncommon) customer needs. The UI listing of customer goals may be empirically driven based on derived data from historical customer calls. The UI listing of customer goals may be written in the language of the customer so that the CSR can match the customer's requests to the UI listing of goals. For example, if the customer says “My bill is too high,” the CSR can match that language to the “Bill too high” listing.

GUIs may be compatible with various Operating Systems (OS). GUIs may serve to create an environment where applications may be selected and opened through typical graphical user interaction. Among other ways, users may be able to manage and execute applications using a “point-and-click” method on objects shown on the computer display. The GUIs may provide an interface for interaction with exemplary embodiments.

The GUI background may be typically referred to as the “desktop” or workspace, and “objects” may be typically displayed on the desktop. Opened applications or objects may be represented by a graphical icon located in the viewable area of current “toolbars,” or in toolbox displays within the viewable area of a screen. For example, some users may locate toolbars at the bottom or the top of the viewable screen area or locate the toolbars to one side of the viewable screen area. By clicking on the graphical icons in a toolbar a user may switch between applications viewable in the workspace. Many applications may use menus on the GUIS that may be forms of hierarchical menus. Hierarchical menus may have files, programs and software utilities grouped together in a manner that may result in a potentially dysfunctional user interaction. Once a menu is opened, a hierarchical menu may have to be opened, and another hierarchical menu may have to be opened before the desired file or utility can be opened.

At block 230, the CSR 112 may select one of the customer goals from the UI as requested by the customer. Customer goals may be related to either sales or service needs. For example, the customer may claim that their bill was incorrect. The CSR 112 may select that option from the UI.

Next, at block 240, a step by step method for the stated goal may be followed. Following the selection at block 230, the UI may present the CSR 112 with a step by step method to follow to attempt to resolve the customer's stated goal. The step by step method may be a “wizard” type method to guide the CSR 112 in addressing the customer's stated goal. For example, if the customer's bill was incorrect, the method may present steps to ask the customer what may be incorrect and the steps may direct the CSR 112 to appropriate action thereto.

It should be appreciated that the customer may have multiple stated goals to address with the CSR 112. The steps of blocks 220 through 240 may be repeated as needed to address each stated goal of the customer. Typically, the stated goals may be addressed prior to continuing with the method 200 at block 250.

At block 250, the CSR 112 may be presented with recommended goals to pursue with the customer. The CSR 112, following addressing the customer's stated goal, may be presented with one or more recommended goals to pursue with the customer. The recommended goal may be an unstated goal. The unstated goals may be provided by the recommendation engine 126. In one or more exemplary embodiments, unstated goals may be related to sales. Unstated goals may not be stated explicitly by the customer. The UI may provide the CSR with guidance on which unstated goals to pursue, when to pursue them, and how long to pursue them, as provided by the recommendation engine 126. For example, the UI may direct the CSR to offering the customer a package containing items the customer does not currently have. The package may be a new offering from the company. The recommendation engine 126 may analyze the account of the particular customer and provide a tailored unstated goal recommendation. For example, the customer may have a history of purchasing a certain product. An unstated goal may be to offer the customer an improvement on that product or a bundle of products associated with the particular product.

Continuing at block 260, the CSR may select and pursue the chosen recommended goal with the customer. A step by step method may guide the CSR in offering the recommended goal to the customer. Guidance may be provided on how to best sell the unstated goal to the customer.

It should be appreciated that multiple recommended goals may be presented to pursue with the customer. The steps of blocks 250 and 260 may be repeated as necessary. It should be appreciated that unstated goals may be selected as required and/or desired by the CSR to offer to the customer. The number may be pre-determined by the company and/or it may be based on the customer's reactions and needs. In some embodiments, one unstated goal may trigger a second unstated goal and so forth. The unstated goals may be triggered the stated goal of the customer.

At block 270, the call may be ended.

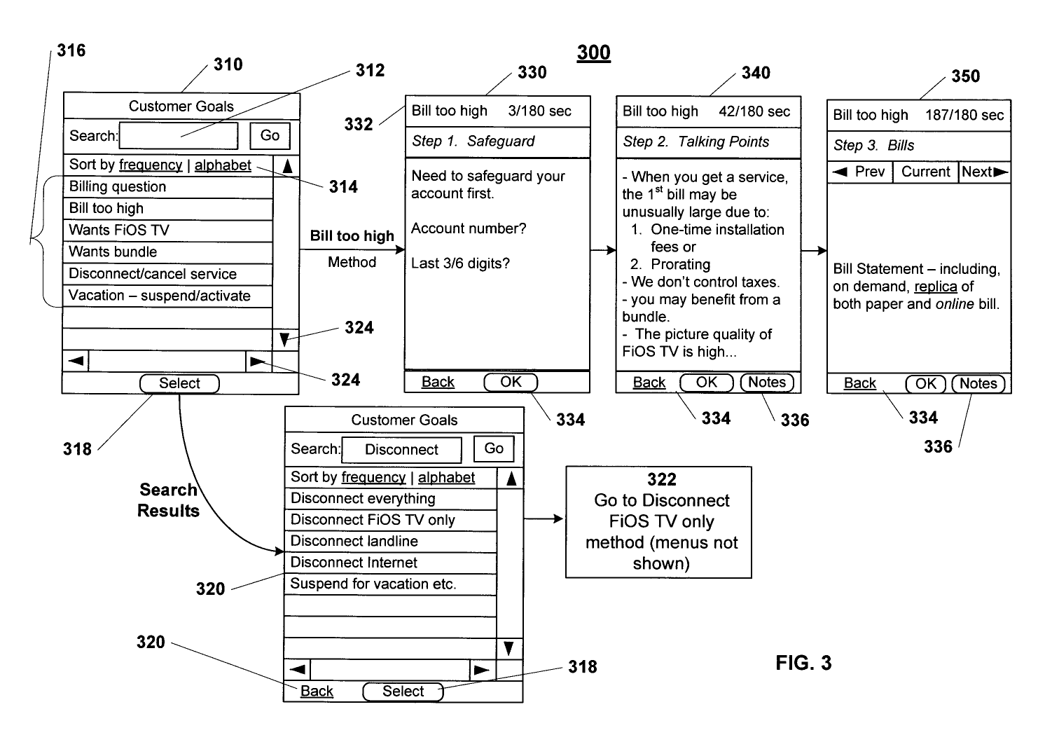

FIG. 3 depicts a menu architecture for a customer goals UI according to an exemplary embodiment. The menus depicted may be used to implement the method of FIG. 2. The CSR system 300 may include, among other things, a customer goals menu 310, a search results menu 320, and method menus 330, 340, and 350. Other various components and embodiments may be provided. The UI menus shown in FIG. 3 are exemplary only. Other such UI menus may be possible as is appreciated.

The customer goals menu 310 may represent a menu of customer goals. The customer goals may be the stated goals of the customer. The customer goals menu 310 may represent the UI displayed for the CSR, such as the CSR 112, as described in block 220 of FIG. 2. Such a menu may be displayed to the CSR 112 when a customer call is answered. The menu 310 may have a search box 312, a sort by selection 314, a list of menu choices 316, and a select button 318. The customer goals menu 310 may incorporate scroll arrows 324. Arrows 324 may allow the CSR 112 to scroll or move the list of menu choices 316 to view items that may not be visible on the present window.

A search term may be entered into the search box 312. Upon entering the search term, a “go” button may be actuated. The actuation of the “go” button may consist of clicking the “go” button using an on-screen cursor and/or actuating a carriage return on an attached keyboard. Upon actuation of the search, the search results may be displayed as shown by the search results window 320. For example, the term “disconnect” may be entered into the search box 312 by the CSR 112. Upon clicking the “go” button, a search results menu 320 may be presented to the CSR 112 with the results of the search.

The menu 312 may have a sort by selection 314. Different options may be presented to sort the list of menu choices 316. As depicted in FIG. 3, sort options of “frequency” and “alphabet” may be presented. By actuating a chosen sort by option the list of menu choices 316 may be altered. For example, selecting “alphabet” may cause the list of menu choices to be displayed in alphabetical order. By selecting “frequency,” a the list of menu choice may be altered to be displayed with the most selected menu choices at the top of the list. The list may be subsequently ordered in decreasing frequency of selection. As shown in the search results window 320, the sort by selection 314 may be displayed with the search results to allow altering the list of search results.

The list of menu choices 316 may be a listing of customer goals. The listing may be empirically derived from historical customer call data such that the list has the most common and/or comprehensive customer goals incorporated.

The select button 318 may allow the CSR 112 to go to the next menu level. For example, the CSR 112 may select “Bill too high” from the list of menu choices 316 and then click the select button 118. Upon clicking the select button 318, a new set of menus may be presented to the CSR 112. The select button 318 may also be present on the search results window 320. For example, the CSR 112 may select “Disconnect FiOS TV only” from the search results window 320 and click the select button 318. A new set of corresponding menus 322 may be displayed. The menus 322 are not shown in FIG. 3. The search results window 320 may incorporate a “back” button 326 in addition to the select button 318.

The menu 310 may incorporate scroll arrows 324. The arrows 324 may allow the CSR 112 to scroll or move the list of menu choices 316 to view items that may not be visible on the present window. The arrows 324 may be paired as shown to provide both up/down and/or left/right movement of the information display.

The menu 330 may represent a menu displayed following selection from the menu 310. The menu 330 and the menus which follow may be part of the step by step method presented to the CSR 112 to attempt to satisfy the customer's stated goal. Such menus may be referred to as wizards or assistants. The menu 330 may be a safeguarding step to verify the customer's information to safeguard the customer's account. Such safeguarding may prevent fraud. The menu 330 represents one such question that the CSR 112 may ask the customer. It should be appreciated that other questions may be asked, such as “please verify your service address.”

The menu 330 and the subsequent menus may incorporate a title bar 332. The title bar 332 may have the name of selection from the menu 310 and a display of the handling time of the call compared to the goal for handling time for such a call. For example, this is depicted in the title bar 332 on the menu 330 by “3/180 sec.” This represents that, in this example, the CSR 112 has been working with the customer for 3 seconds and the goal for handling this call is 180 seconds. It should be appreciated that such metrics may be recorded and used to evaluate the performance of the CSR 112.

The menu 330 and the subsequent menus may incorporate an action bar 334. The action bar 334 may include a “back” button and a “OK” button. The “back” button may allow return to a previous menu. The “OK” button may allow the CSR 112 to proceed to the next menu.

The menu 330 and the subsequent menus of an exemplary embodiment may rely upon default selections. Information required may be filled in on the menu 330 and subsequent menus and/or UI when they are first displayed to the CSR 112. For example, customer data, such as account number, may be pre-filled. Certain selections on the menu may be pre-selected, such as a package of services. Through the use of pre-filling of information, default selections may be relied upon by the CSR, increasing the speed of interaction with the customer compared to the CSR having to select or fill out every field. With default selections, the CSR may have to change what the customer does not agree to.

The menu 340 represents the next step in the process. The menu 340 may provide talking points for the CSR 112 to address the customer's goal. The talking points may be very detailed. Provision of talking points may standardize responses to customers, such that the customer may receive the same information no matter what CSR they talk to.

The menu 340 may incorporate an additional button on the action bar 334. A “Notes” button 336 may be incorporated. The “Notes” button may allow a CSR 112 to open a separate window wherein the CSR may enter text comments to memorialize the call with the customer. Such notes may allow another CSR 112 to effectively address any future issues the customer may have, if they call back.

The menu 350 may present the next and final step in the process. In this example, the menu 350 provides a note for the CSR 112 to provide the customer with a bill statement. The menu 350 may incorporate the “Notes” button 336.

Upon clicking the “OK” button on the menu 350, the CSR 112 may be taken back to the menu 310. The CSR may then address any additional goals the customer may have. The CSR may be taken to an unstated goals menu (not shown).

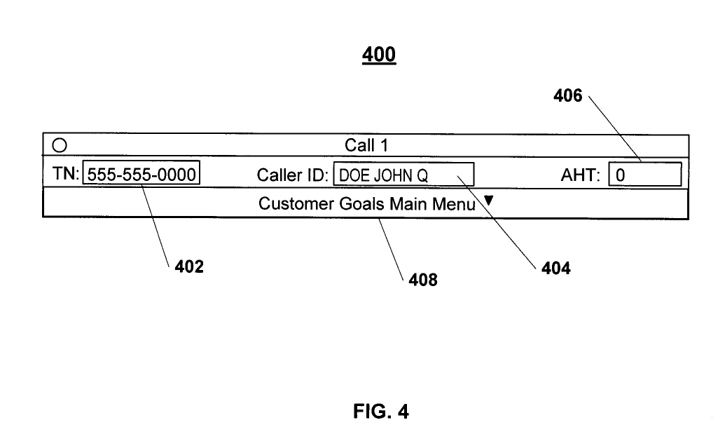

FIGS. 4 through 10 depict menu architectures of various UIs for CSR menus according to an exemplary embodiment. Other various components and embodiments may be provided. The UI menus shown in FIGS. 4 through 11 are exemplary only. Other such UI menus and menu structures may be possible as is appreciated. The UI architectures of FIGS. 4 through 11 will now be described.

FIG. 4 depicts an information UI according to an exemplary embodiment. The UI 400 may represent the initial menu that a CSR 112 may receive upon starting a call with a customer. The UI 400 may contain various information fields. The telephone number 402 of the customer may be displayed. The telephone number (TN) 402 may be displayed automatically based upon a caller ID function resident in an exemplary embodiment. The caller ID 404 may display the name of the customer who is calling. The average handling time (AHT) 406 may display the handling time of the present customer call. The customer goals menu selection bar 408 may allow the CSR 112 to activate a drop down menu for interaction with the customer in accordance with an exemplary embodiment. For example, the customer goals menu selection may allow the CSR to perform the steps of the exemplary method described in FIG. 2. It should be appreciated that other arrangements of the UI 400 may be possible. At least a portion of the UI 400 may remain at the top of the display during all subsequent UI selections.

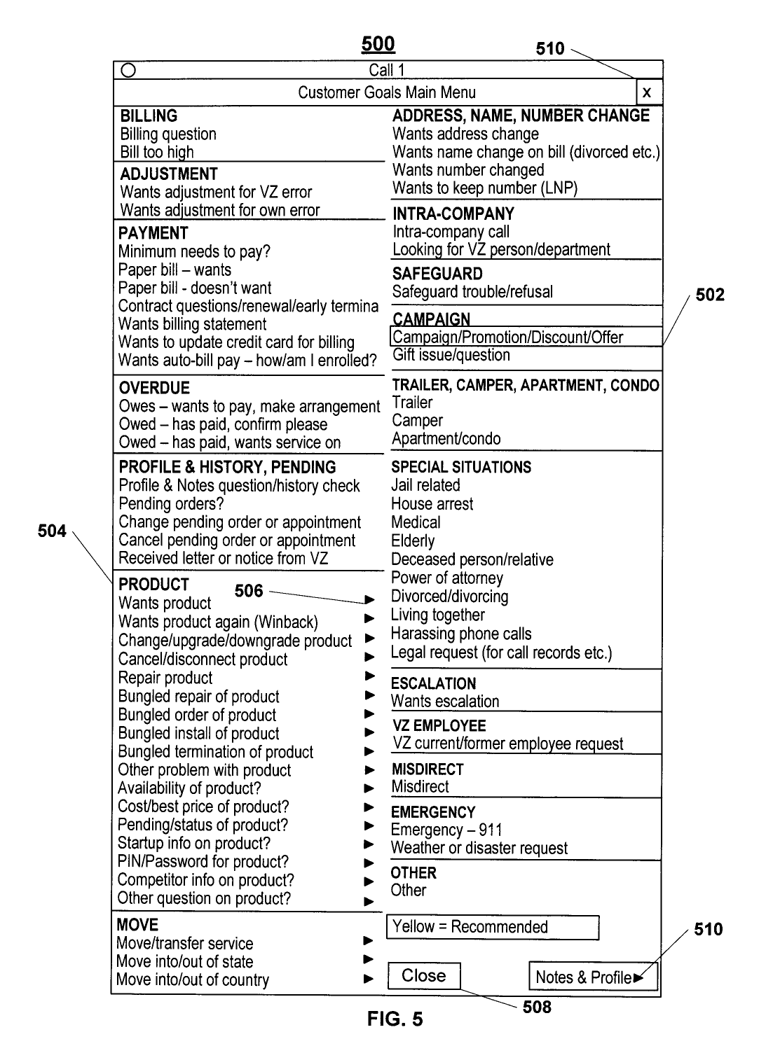

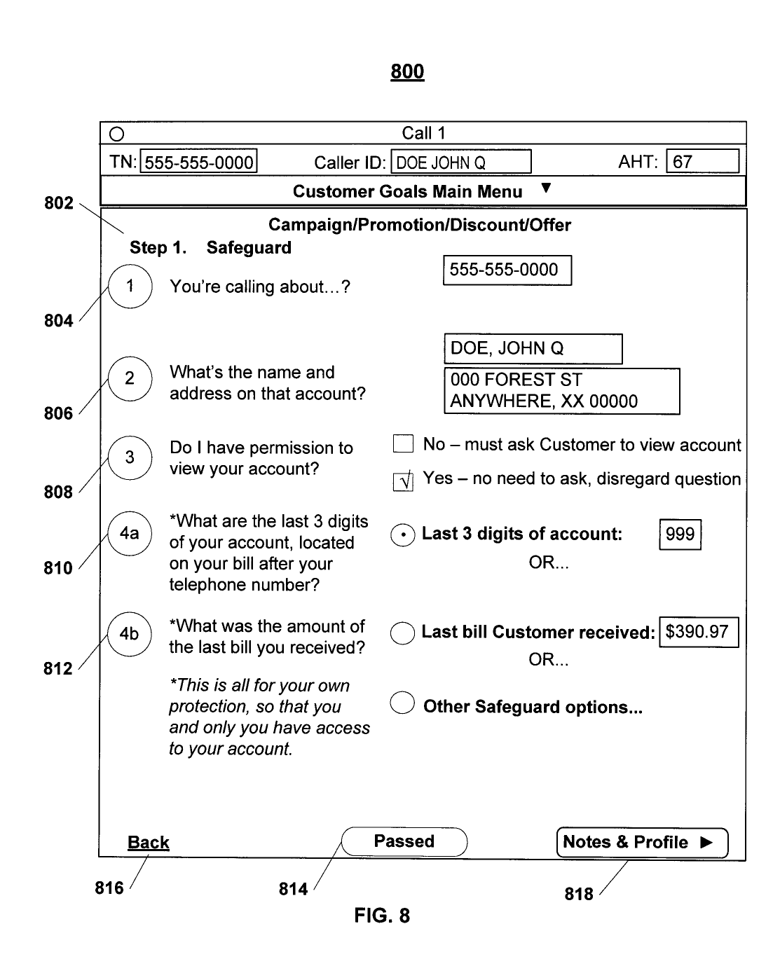

FIG. 5 depicts a customer goals main menu in accordance with an exemplary embodiment. A customer goals main menu 500 may be selected by using the customer goals menu selection bar 408 as depicted in FIG. 4. The customer goals main menu may drop down from the UI 400 upon selection thereof. The customer goals main menu 500 may represent a menu of empirically derived customer goals. The customer goals main menu 500 may incorporate unstated goals desired by the company to convey to customers as discussed above. For example, the Campaign/Promotion/Discount/Offer menu 502 may contain unstated goals. Such unstated goal sections may be highlighted or distinguished in a manner to flag the CSR's attention. For example, the unstated goals, such as the Campaign/Promotion/Discount/Offer menu 502, may be highlighted in yellow. The Campaign/Promotion/Discount/Offer menu 502 is described below in FIGS. 8 through 10.

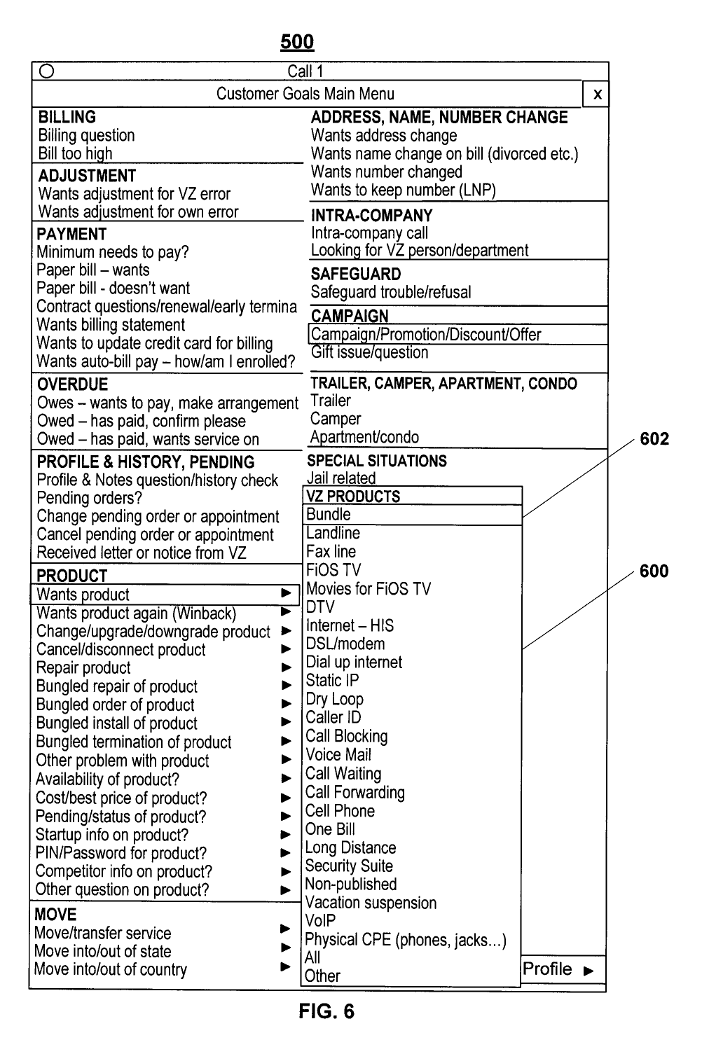

Certain selections upon the customer goals main menu 500 may have sub-menus associated with them. For example, the product section 504 may have sub-menus as shown by the selection arrows 506. An exemplary embodiment of these sub-menus are depicted in FIG. 6. Other selections on the customer goals main menu 500 may activate one or more UIs upon selection. The subsequent UIs may provide a step by step method for the CSR to accomplish the customer stated or unstated goal.

FIG. 6 depicts a customer goals sub-menu in accordance with an exemplary embodiment. The sub-menu 600 may be selection from the selection arrows 506. The sub-menu 600 may appear overlayed on the customer goals main menu 500. The sub-menu 600 may be used for products and/or services which may change often. By placing such products and/or services in such a sub-menu, updates and changes to the products and/or services may be performed without impacting the layout of the customer goals main menu 500.

The customer goals main menu 500 may be closed by the CSR by selecting either the “close” button 508 or the “X” button 510. Upon selection of a closure button, the customer goals main menu may be removed from display. The UI 400 may then be displayed for the CSR 112.

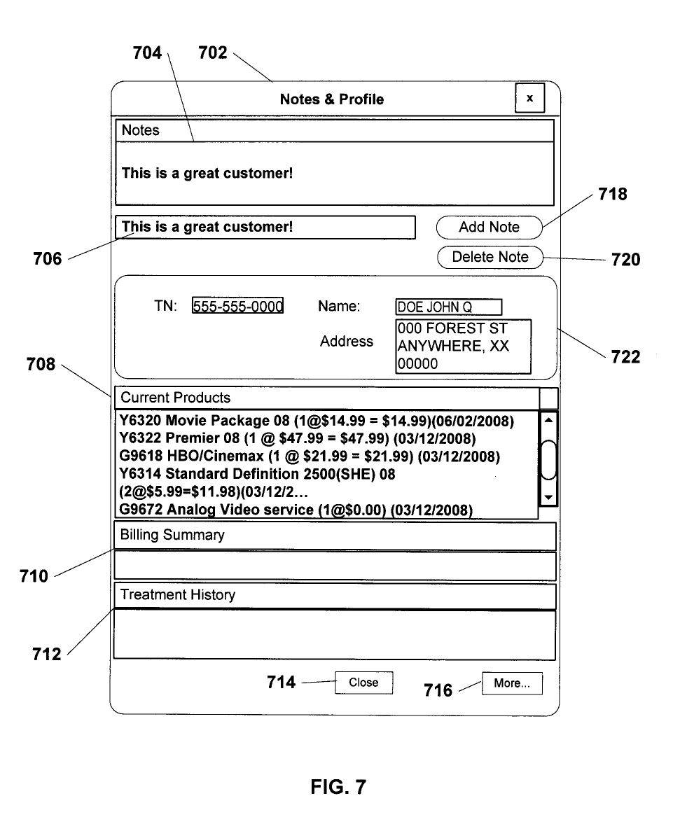

FIG. 7 depicts a notes and profile UI in accordance with an exemplary embodiment. The customer goals main menu 500 may include a notes and profile selection button 510. Upon selection of the selection button 510, a notes and profile UI 702 may be activated. The notes and profile UI 702 may allow a CSR to view profile information relating to the customer. The notes and profile UI 702 may allow a CSR to enter notes during the call with the customer to document issues and the discussion with the customer. The notes and profile UI 702 may allow other CSRs to review information about this particular customer during subsequent calls. The notes and profile UI 702 may therefore allow the CSR 112 to have an available source of information regarding a particular customer which may promote standardized dealing with customers. The notes and profile UI 702 may be displayed on the screen with the customer goals main menu 500. The notes and profile UI 702 may be displayed next to the customer goals main menu 500 on the CSR's display. In some embodiments, the notes and profile UI 702 may be displayed such that the notes and profile UI 702 is overlaid on the customer goals main menu 500.

The notes and profile UI 702 may have a notes section 704. The notes section 704 may allow the CSR 112 to review notes about the customer. The notes section 704 may contain a listing of notes taken about the particular customer during previous calls. A note entry bar 706 may be included to allow the CSR 112 to enter notes, typically in text format, as desired. Any notes entered in the note entry bar 706 may be appended to the listing of notes in the notes section 704. In some embodiments, a date stamp (not shown) may be appended to any notes entry made. In some embodiments, a tag (not shown) containing the identification of the CSR 112 who entered the note may be appended to the particular note entry, such as the initials of the CSR 112. The note entry bar 706 may include an “add note” button 718 and a “delete note” button 720. The “add note” button 718 may be used to enter the text from the note entry bar 706. The “delete note” button 720 may be used to remove text entered in the note entry bar 706.

A current products section 708 may be included. The current products section 708 may include a listing of the customers current products and/or services. Such a listing may provide the CSR 112 with knowledge regarding what the customer may have. This listing may enable the CSR 112 to provide recommendations for additional products and/or services for unstated customer goals.

Additional information fields may be included in the notes and profile UI 702. For example, a billing summary window 710 and treatment history 712 may be included. These fields may provide the CSR 112 with additional information about the customer. For example, the billing summary window 710 may contain a summary of the customers current and past bills. The treatment history 712 may contain a summary of past goals accepted and/or declined by the customer. All such information may be of use to the CSR 112 in handling a particular customer. A customer profile window 722 may be included. The customer profile window 722 may provide information regarding the customer, such as telephone number, name, and address. Other fields may be included, such as additional telephone numbers and other addresses, such as separate billing and service addresses.

The notes and profile UI 702 may include a close button 714. The close button 714 may allow the CSR 112 to close the notes and profile UI 702. The notes and profile 702 may include a “more” button 716. The “more” button 716 may be used to access additional notes and profile UI 702 information that may not be able to fit within one display as depicted in FIG. 7. In some embodiments, if no additional information is available, the “more” button 716 may not be present on the notes and profile UI 702. The “more” button 716 may be non-functional if no further information is available.

FIG. 8 depicts a UI according to an exemplary embodiment. UI 800 may represent the first step by step or wizard menu shown to the CSR 112 upon selection of a menu item, such as from the customer goals main menu 500. For example, the CSR 112 may select the campaign selection 502. Upon selection of the campaign selection 502, the UI 800 may appear on the display for the CSR. The UI 800 may substantially replace the customer goals main menu 500 on the screen. The customer information, as depicted in the UI 400 may be displayed on the UI 800. The UI 800 may be structured to provide the CSR 112 with a delineated set of steps to follow to attempt to address the goal selected by the CSR 112. Such a delineated set of steps may facilitate uniformity in dealings with customers.

The UI 800 may represent a UI for the first step of a step by step process for a selected menu item. For example, the UI 800 may be an exemplary embodiment for the Campaign/Promotion/Discount/Offer menu 502. The UI 800, and the subsequent UIs which follow it, may be modified as appropriate to present steps to address the selected menu item from the customer goals main menu 500. As shown by the label 802, the first step may be a safeguarding step to ensure that the customer may be who they say they are. Such a safeguarding step may prevent fraud. A series of steps may be provided on the UI 800 such as blocks 804 through 812. The blocks may be sequentially numbered as depicted on UI 800. In an exemplary embodiment, the blocks 804 through 812 may walk the CSR 112 through a series of questions to verify the customer's identity. The CSR 112 may be provided with the answers to the questions as shown on the UI 800. Blocks 810 and 812 may represent alternative safeguard questions. The CSR 112 may ask the customer to chose which information to provide. Block 812 may allow selection of additional safeguard options (not shown). Upon completion of the blocks on the UI 800, the CSR 112 may select the passed button 814. Selection of the passed button 814 may allow the CSR to proceed to the next screen. A back button 816 may be provided to allow the CSR to go back to a previous menu, such as the customer goals main menu 500. A notes and profile button 818 may be provided. Selection of the notes and profile button may bring up the notes and profile UI 702. The notes and profile UI 702 may be displayed upon the screen with the UI 800. The CSR 112 may have predetermined instructions on how to act or proceed if the customer fails any and/or all of the safeguard questions.

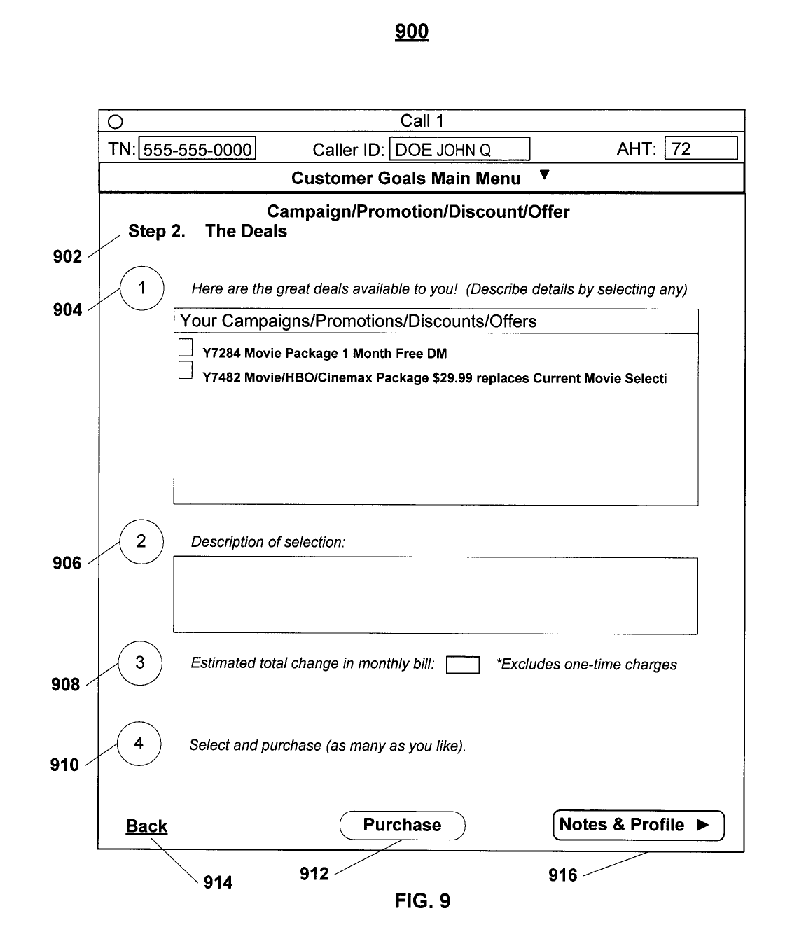

FIG. 9 depicts a UI according to an exemplary embodiment. The UI 900 may represent a second step in the step by step process, as shown by the label 902. The customer information, as depicted in the UI 400 may be displayed on the UI 900. The UI 900 may represent a UI with the actual deals being offered on products and/or services to the customer. The UI 900 may be selected to appear by selection of the passed button 814 from the UI 800. The UI 900 may have a series of sequential blocks 904 through 910 for the CSR 112 to follow. The blocks 904 through 910 may allow the CSR to complete the offer of the product and/or service to the customer. In block 904, a series of deals may be presented. The CSR 112 may select one or more of the presented deals. Upon selection of the one or more deals, typically by clicking on the associated box with the deal, a description of the selected deal(s) may be displayed in block 906. An estimated charge for the selected deals may be displayed in block 908. Upon completion of the selections, the CSR 112 may select the purchase button 912 to complete this step. A back button 914 may be provided to allow return to a previous UI or menu, such as the UI 800. A notes and profile button 916 may be included. Selection of the notes and profile button may bring up the notes and profile UI 702. The notes and profile UI 702 may be displayed upon the screen with the UI 900.

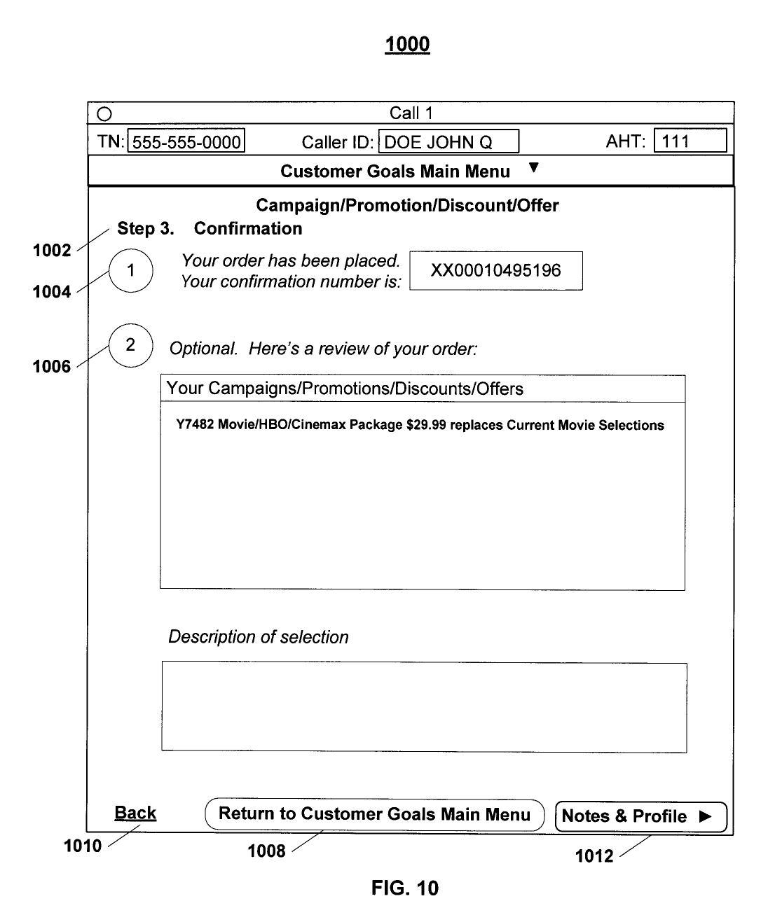

FIG. 10 depicts a UI according to an exemplary embodiment. The UI 1000 may represent a third step in the step by step process, as shown by the label 1002. The customer information, as depicted in the UI 400 may be displayed on the UI 1000. The UI 1000 may represent a UI with the products and/or services agreed upon in the UI 900. The UI 1000 may be selected to appear by selection of the purchase button 912 from the UI 900. The UI 1000 may have a series of sequential blocks 1004 through 1006 for the CSR 112 to follow. The blocks 1004 through 1006 may allow the CSR to complete the purchase of one or more products and/or services to the customer. In block 1004, a confirmation number may be generated. Block 1006 may provide a summary and description of the order for review with the customer. Upon completion of the order review, the CSR 112 may select the return button 1008 to complete this step. The return button 1008 may return the CSR to the customer goals main menu 500. Upon return, the CSR may select other customer goals from the menu. A back button 1010 may be provided to allow return to a previous UI or menu, such as the UI 900. The back button may allow the order to be altered. A notes and profile button 1012 may be included. Selection of the notes and profile button may bring up the notes and profile UI 702. The notes and profile UI 702 may be displayed upon the screen with the UI 1000.

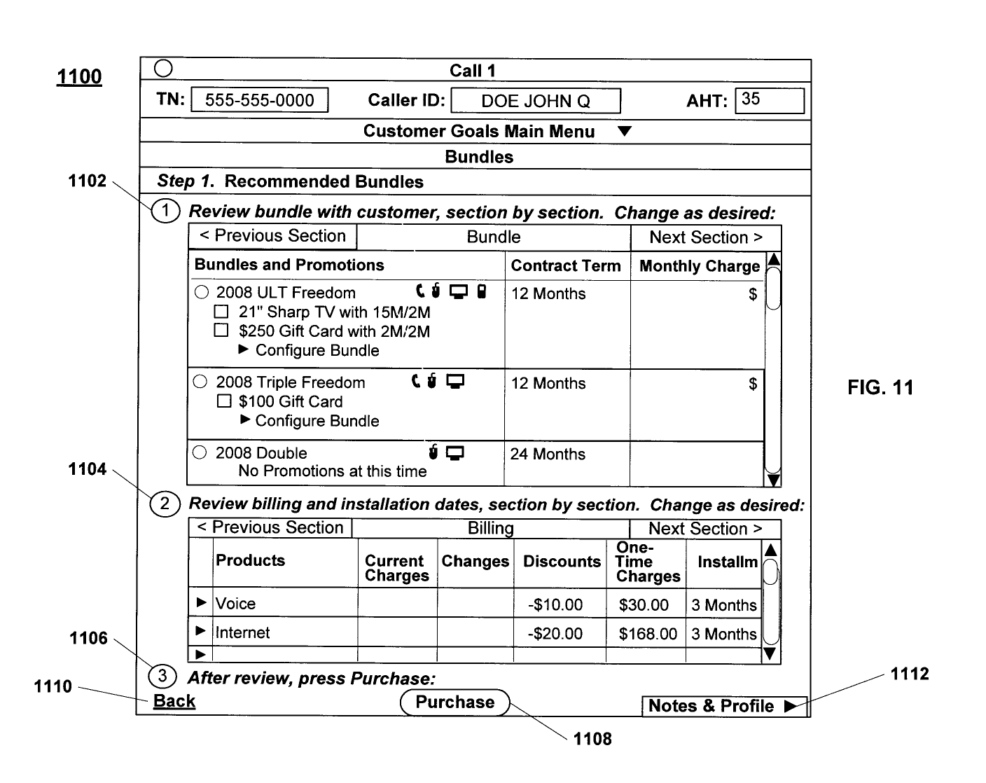

FIG. 11 depicts an alternative UI according to an exemplary embodiment. UI 1100 may be an alternative UI structure for completing a step by step process for a selection from the customer goals main menu 500. An exemplary embodiment is shown for a selection of the bundles option 602 as depicted in FIG. 6. The customer information, as depicted in the UI 400 may be displayed on the UI 1100 The UI 1100 may present an ala carte style menu that presents numerous choices for the CSR 112 to choose from. The UI 1100 may present all needed steps on one screen which may allow faster completion of the goal with the customer as compared to using multiple screens. By displaying all available information related to the selection on the screen at once, the CSR 112 may have access to information required to answer customer questions regarding the selections.

The UI 1100 may have a series of sequential blocks 1102 through 1106 for the CSR 112 to follow. The blocks 1102 through 1106 may allow the CSR to offer of the product and/or service to the customer. More than one product and/or service may be offered to the customer. In block 1102, an input section of the UI may be provided for input from the CSR 112. The CSR 112 may configure the request in this section as desired. A series of offers or deals may be presented. The CSR 112 may select one or more of the presented deals. Upon selection of the one or more deals, typically by clicking on the associated box with the deal, additional information regarding the selected deals may be displayed on the UI 1100. For example, the contract term and the monthly charge may be displayed. The CSR 112 may be presented with a scroll bar of the display of 1102 to allow viewing of all applicable offers. Upon completion of the selections, the CSR 112 may proceed to block 1104 to review the selections with the customer. Block 1104 may provide an output window whereby the CSR 112 may receive feedback related to the choices made in block 1102. The CSR 112 may review the choices and review the feedback presented with the customer. Block 1104 may present a summary of the selections from block 1102. Various information may be displayed in block 1104. Options may be presented to the CSR 112 to scroll or flip through various levels of information, as shown by the “previous section” and “next section” headings in block 1104. Block 1106 may be a reminder to complete the purchase by selecting the purchase button 1108. A back button 1110 may be provided to allow return to a previous UI or menu, such as the customer goals main menu 500. A notes and profile button 1112 may be included. Selection of the notes and profile button may bring up the notes and profile UI 702. The notes and profile UI 702 may be displayed upon the screen with the UI 1100. The bottom section of the UI 1100 which has the buttons 1108, 1110, and 1112 may present an action section for the UI 1100.

UI 1100 depicts a UI related to an order for one or more products or services. Such an order may result in a billing to the customer that is consummated with the selection of the purchase button 1108. It is understood that the steps presented in a UI, such as UI 1100, may be altered depending upon the customer goal being addressed. For example, if the customer has a question, such as “why is my bill $X.XX,” the CSR may select the appropriate choice from the customer goals main menu 500 resulting in UI 1100 appearing. The step 1102 may have a selection of questions presented. The CSR 112 may select the appropriate question to address the customer's need. Step 1104 may then present an answer or answers to the question selected. The button 1108 may read “Done” instead of “Purchase.” Another example may be the customer having a request, such as “I want my telephone disconnected.” The step 1102 may present different variations of the request for the CSR 112 to select. The step 1104 may then contain responses to the request selected. The button 1108 may read “Do” instead of “Purchase.” Another example may be the customer having a complaint, such as “there is static on my TV screen.” The step 1102 may have a selection of options related to such a complaint. The step 1104 may have remedies or solutions to the complaint. The button 1108 may read “Do” or “Done” instead of “Purchase.” These examples are for illustrative purposes only and it is understood that other situations are possible leading to different structures to the UI 1100.

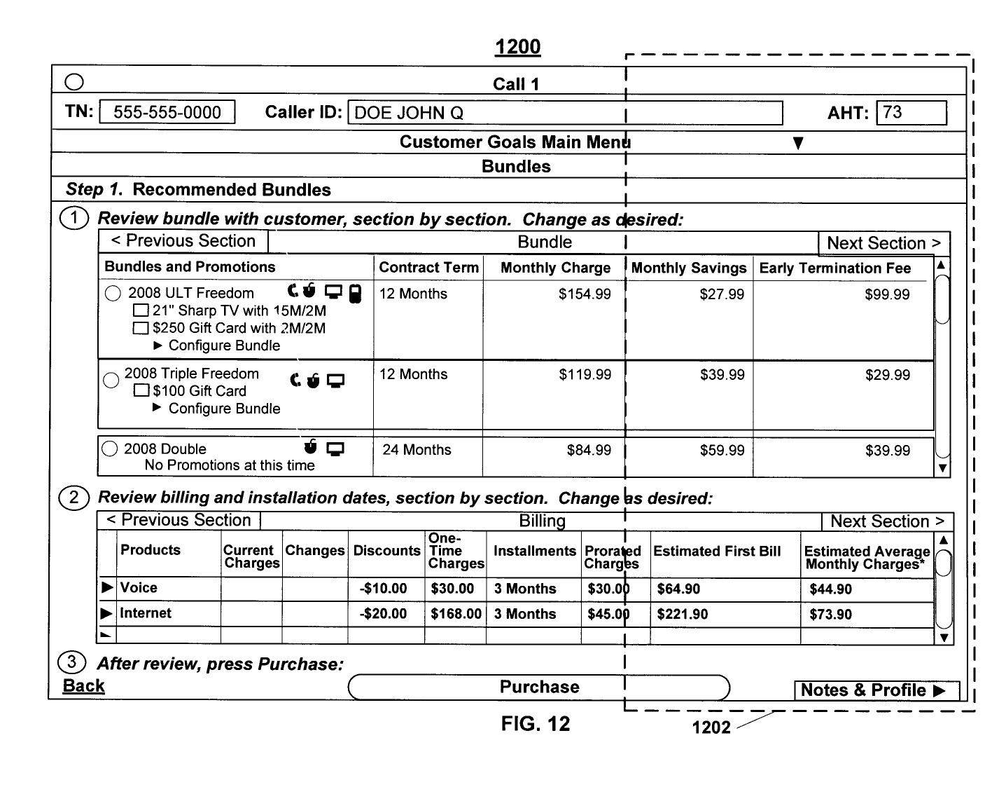

FIG. 12 depicts a resized UI according to an exemplary embodiment. UI 1200 depicts the UI 1100 expanded to allow more information to be displayed. The box 1202 indicates the expanded data from the UI 1100. All the UI's and menu options according to an exemplary embodiment may be resized as such. The resizing feature may allow a CSR 112 to adjust a UI to display the information the CSR 112 requires. The resizing of the window may be limited by the display screen size of the display the CSR 112 may have associated with the client side 110.

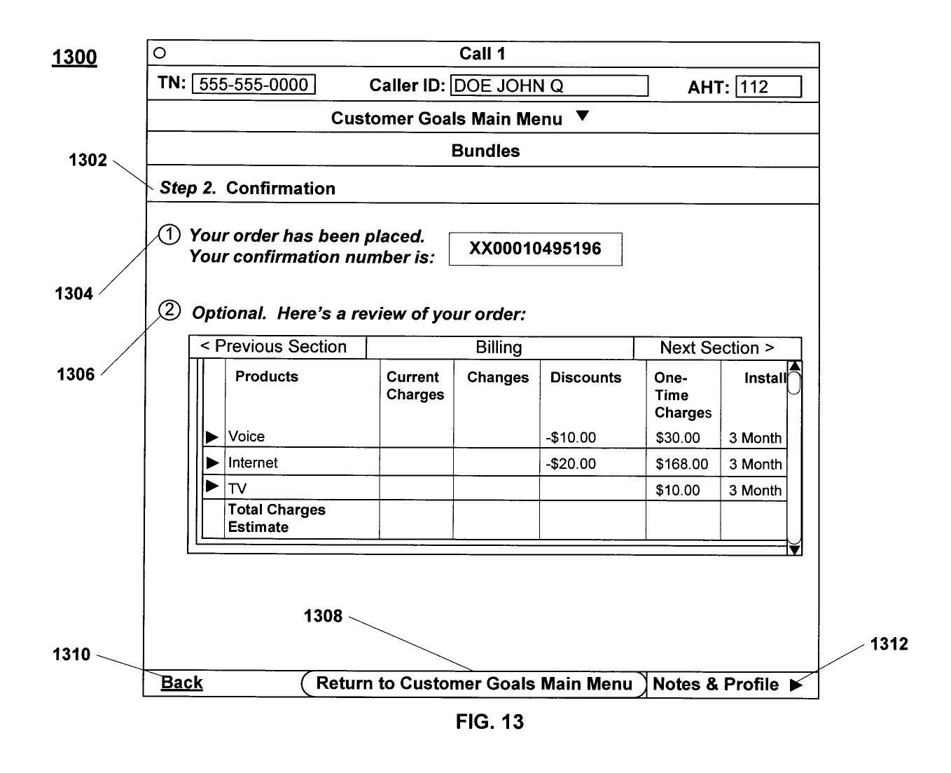

FIG. 13 depicts a alternative UI according to an exemplary embodiment. The UI 1300 may represent a final step in the step by step process, as shown by the label 1302. The customer information, as depicted in the UI 400 may be displayed on the UI 1300. The UI 1300 may represent a UI with of the products and/or services agreed upon in the UI 1100. The UI 1300 may be selected to appear by selection of the purchase button 1108 from the UI 1100. The UI 1300 may have a series of sequential blocks 1304 through 1306 for the CSR 112 to follow. The blocks 1304 through 1306 may allow the CSR to complete the purchase of one or more products and/or services to the customer. In block 1304, a confirmation number may be generated. Block 1306 may provide a summary and description of the order for review with the customer. Upon completion of the order review, the CSR 112 may select the return button 1008 to complete this step. The return button 1308 may return the CSR to the customer goals main menu 500. Upon return, the CSR may select other customer goals from the menu. A back button 1310 may be provided to allow return to a previous UI or menu, such as the UI 1100. The back button may allow the order to be altered. A notes and profile button 1312 may be included. Selection of the notes and profile button may bring up the notes and profile UI 702. The notes and profile UI 702 may be displayed upon the screen with the UI 1300.

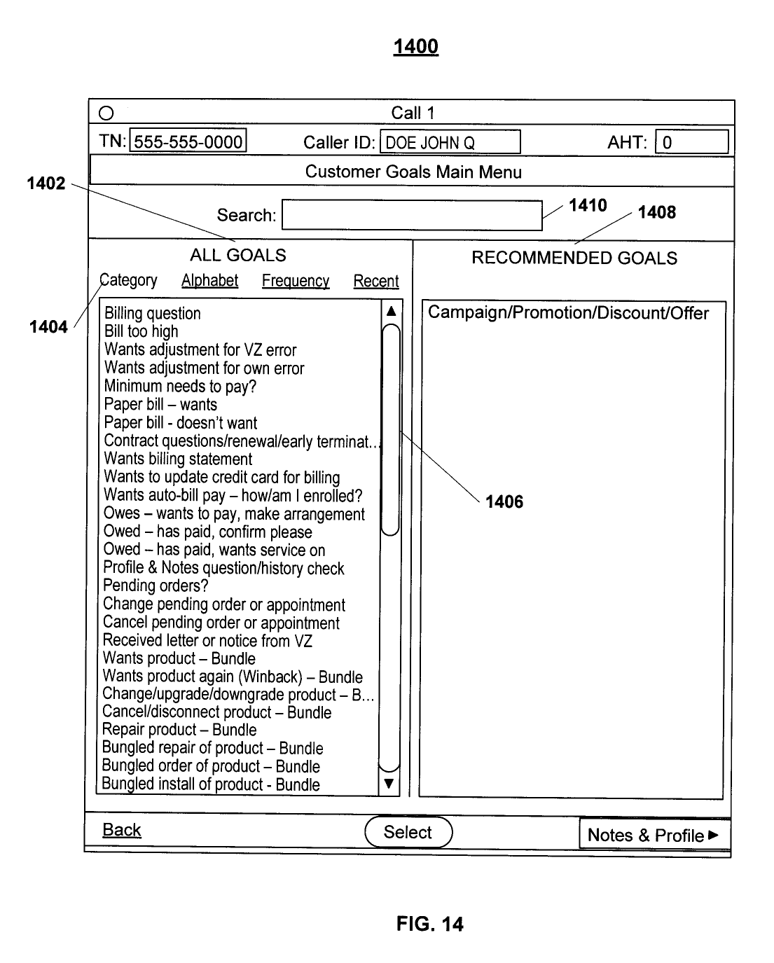

FIG. 14 depicts an alternative customer goals main menu in accordance with an exemplary embodiment. A customer goals main menu 1400 may be displayed. The customer goals menu 1400 may be an alternative to the customer goals main menu 500. The customer goals main menu 1400 may be structured to provide a listing of all customer goals 1402 in a left pane. The listing of goals 1402 may be ordered by selecting a category 1404. Selection of a category may alter the display of goals in the listing of goals 1402. A slide bar 1406 may provide scrolling through the listing of goals. A listing of recommended goals 1408 may be provided in a right pane. The listing of recommended goals 1408 may be a listing of predetermined recommended goals to address with the customer. It should be appreciated that the listing of goals 1402 may be in the right pane and the listing of recommended goals may in the left pane. A search box 1410 may be provided. A search term may be entered into the search box 1410 and the matching or closest matching term in the listing of goals 1402 may be highlighted. Alternatively, the listing of goals 1402 may alter to only display the matching goal to the search term or a listing of closest matching terms. The remainder of the customer goals main menu 1400 may be similar in arrangement and functionality to exemplary embodiments described herein.

Any business may derive benefit from an exemplary embodiment, because businesses, by definition, have customers. Exemplary embodiments therefore have significance for meeting and achieving customer goals. Exemplary embodiments may help the business which the CSR supports because a common framework for coding all goals may be presented and the average handling time may be reduced because each CSR may operate similarly across all customer goals. The method can be ported to mobile devices for door-to-door sales representatives, as well.

In the preceding specification, various exemplary embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

1. A computer implemented method, comprising:
displaying a main user interface to a customer service representative in response to the customer service representative receiving a call from a customer, wherein the main user interface comprises a listing of at least one customer goal;
receiving a first selection from the listing, wherein the first selection is selected by the customer service representative as determined from a first query from the customer;
generating at least one subsequent user interface in response to the first selection, wherein the at least one subsequent user interface comprises at least a first series of steps for the customer service representative to follow to address the first query;
receiving at least one input from the customer service representative, the at least one input being entered into the at least one subsequent user interface;
displaying a recommended selection of one or more customer goals on the main user interface, wherein the recommended selection is selected by the customer service representative and differs from the first selection;
receiving a second selection of one or more customer goals based upon the recommended selection;
generating one or more subsequent user interfaces in response to the second selection, wherein the one or more subsequent user interfaces comprises at least a second series of steps for the customer service representative to follow to address recommended selection;
receiving one or more inputs into the one or more subsequent user interfaces; and
displaying the main user interface in response to receiving the one or more inputs.

2. The method of claim 1, further comprising:
receiving a selection of a subsequent recommended selection;

3. The method of claim 1, wherein listing of one or more customer goals is based on empirical data from previous calls from customers.

4. The method of claim 1, wherein the recommendation comprises a predetermined goal.

5. The method of claim 1, wherein the recommendation is targeted to the customer.

6. The method of claim 1, wherein the recommendation comprises a sales objective, comprising a sale of one or more products and services to the customer.

7. The method of claim 1, wherein the first query from the customer comprises at least one of a sales and service query.

8. The method of claim 1, further comprising:
displaying information related to an account associated with the customer.

9. The method of claim 1, further comprising:
display an notes user interface wherein the customer service representative enters information related to the call.

10. The method of claim 1, further comprising:
receiving verification of an identity of the customer, wherein the identity is verified through a series of questions displayed upon a safeguard user interface.

11. A system, comprising:
a client side, comprising one or more processors and a display, for displaying a first user interface and one or more subsequent user interfaces for receiving inputs from a customer service representative, for transmitting the received inputs to a server side, and for receiving and displaying transmitted responses from the server side,
the one or more user interfaces being displayed on the display associated with the customer service representative in response to a selection from the first user interface, the selection being made by a customer service representative in response to a first query from a customer;
the server side, comprising one or more processors, communicatively coupled to the client side, for receiving inputs from the client side, for processing the received inputs, and for transmitting responses to the client side; and
a recommendation module communicatively coupled to the server side for providing recommended selections to the customer service representative,
wherein the one or more user interfaces are altered in response to the received inputs from the server side.

12. The system of claim 11, further comprising:
one or more databases, communicatively coupled to the server side, the one or more databases comprising at least customer and product information, wherein the one or more databases are accessed by the server side in response to information requests;
wherein further the one or more user interfaces are altered in response to a second query from the customer service representative, wherein the second query differs from the first query and is based at least on the recommended selections.

13. The system of claim 11, wherein the first query is related to at least a sales or service objective associated with the customer.

14. The system of claim 11, wherein the second query is related to a predetermined sales objective.

15. The system of claim 11, wherein the one or more user interfaces comprise graphical user interfaces.

16. The system of claim 11, wherein the one or more interfaces are displayed in response to a call from the customer.

17. The system of claim 11, wherein the phone call is received by the customer service representative.

18. The system of claim 11, wherein the first user interface comprises one or more customer goals.

19. The system of claim 11, wherein a second query is received from the customer.

20. The system of claim 11, further comprising:
one or more portable electronic devices communicatively coupled to the server side, the one or more portable electronic devices comprise one or processors and a display for displaying the first user interface and the one or more subsequent user interfaces for receiving inputs from the customer service representative, for transmitting the receiving inputs to the server side, and for receiving and displaying transmitted responses from the server side,
wherein the one or more portable electronic devices comprise at least a cellular phone and a personal digital assistant.
